(19) United States
(12) Patent Application Publication
(10) Pub. No.: US 2018/0102547 A1
(43) Pub. Date: Apr. 12, 2018

(54) Current Collector

(71) Applicants: Prologium Technology Co., Ltd., Taoyuan City (TW); Prologium Holding Inc., Grand Cayman (KY)

(72) Inventor: Szu-Nan Yang, Taoyuan City (TW)

(21) Appl. No.: 15/727,707

(22) Filed: Oct. 9, 2017

Related U.S. Application Data
(60) Provisional application No. 62/407,019, filed on Oct. 12, 2016.

(51) Int. Cl. H01M 4/66; H01M 10/0525; H01M 4/80; H01M 4/38; H01M 4/134

(52) U.S. Cl. CPC H01M 4/667; H01M 10/0525; H01M 4/80; H01M 4/134; H01M 4/663; H01M 4/382; H01M 4/664

(57) ABSTRACT

A current collector is disclosed in the present invention. The current collector comprises a conductive substrate and a plurality of isolation regions. The conductive substrate has a plurality of holes. Each hole has two openings. The isolation regions, which only partially cover the surface of the conductive substrate, are disposed at least on the areas nearby the peripheral surface of the openings. Due to the electrical insulation of the isolation regions formed nearby the peripheral surface of the openings, the lithium ions would not deposit centrally close to the openings of the holes during the electrical-chemical reaction of the battery. Accordingly, only few lithium dendrites are formed inside the holes and grow towards the separator so that the position and the amount of the formation of the lithium dendrite can be effectively controlled. Thus, the safety of the battery can be greatly improved.

### CROSS REFERENCE TO RELATED APPLICATIONS

This Non-provisional application claims priority under 35 U.S.C. § 119 (a) on Patent Application No. 62/407,019 filed in United States on Oct. 12, 2016, the entire contents of which are hereby incorporated by reference.

### BACKGROUND

### 1. Technical Field

The present invention is related to a current collector and application of electrode, in particular to the current collector having isolation regions, and usually as anode electrode.

### 2. Description of Related Art

As for the conventional lithium battery, the most difficult problem is the formation of lithium dendrite. Since the current collector of anode electrode (usually cooper foil) approaches the lithium relative potential in 0 volts state, in the internal electrochemical reaction of the battery, the lithium deposition is continued on the surface of the current collector, resulting in the formation of a large amount of lithium dendrite. The formation of lithium dendrite not only consumes the amount of lithium inside the battery, and the capacity decreases gradually after cycle times, but also might penetrate through the separator, once the separator damaged would result in the internal shortage or explosion.

One of the common way to solve the problem is adding additives in electrolyte. By adding different additives, the probability of lithium ion deposition is decreased. For example, reducing the activation energy of the formation of SEI (solid-electrolyte-interphase) layer and avoiding the lithium deposition; or provides specific functional groups for forming lithium intermediates to interfere with the lithium deposition. Furthermore, to used specific anode electrode active material; for example, the lithium titanium oxide (LTO) is to avoid the anode electrode active material approaches the lithium relative potential in the state of 0 volts while in the process of charging, that could avoid lithium deposition on the anode electrode layer. However, the above-mentioned methods have some hindrance to the lithium deposition, the use of additives in the electrolyte is usually accompanied with the occurrence of some side effects. Therefore, the lithium deposition is reduced, but some of the side effects will reduce the efficiency of the internal electrochemical reaction of the battery. In addition, the lithium titanium oxide potential is higher than the oxide potential of lithium about 1.5 volts, when using lithium titanium oxide as the active material of anode and using the existed cathode material, the discharge voltage of the battery will be reduced to about 2.4V. Under the premise that the theoretical capacitance of lithium titanium oxide is comparable to that of graphite, the energy density provided by the lithium titanium oxide battery will be sacrificed.

Accordingly, a current collector having an insulating region while maintaining a high energy density is disclosed in the present invention to overcome the above problems.

### SUMMARY OF THE INVENTION

It is an objective of this invention to provide a current collector. The current collector having a plurality of holes that corresponding to the openings, and the electrical insulation of the isolation region formed near the peripheral surface of the openings. This structure could reduce the chance of lithium dendrites depositing on the holes.

It is another objection of this invention to provide a current collector. The isolation regions extended to the areas out of the peripheral surface of the openings, the chance of forming lithium dendrites on the conductive substrate surface can be effectively reduce.

It is another objection of this invention to provide a current collector. The isolation regions are extended to the partially inner surface of the plurality of holes, the chance of the lithium dendrites growing from the holes to the separator can be effectively reduced.

For the above object, the current collector is disclosed in the present invention. The current collector comprises a conductive substrate and a plurality of isolation regions. The conductive substrate has a plurality of holes. Each hole has two openings. The isolation regions, which only partially cover the surface of the conductive substrate, are disposed at least on the areas nearby the peripheral surface of the openings. Because of the electrical insulation of the isolation regions, the lithium ions would not deposit centrally close to the openings of the holes during the electrical-chemical reaction of the battery. Further, it can be effectively reduce lithium dendrites formed inside the holes and grow towards the separator, solving the internal shortage and increasing the safety of the battery.

Further scope of applicability of the present invention will become apparent from the detailed description given hereinafter.

### BRIEF DESCRIPTION OF THE DRAWINGS

FIG. 1A, FIG. 1B, FIG. 1C and FIG. 1D illustrates the current collector having plurality isolation regions of this prevent invention.

FIG. 2A, FIG. 2B, FIG. 2C and FIG. 2D illustrates the current collector having ionic conductive regions evolve from FIG. 1A, FIG. 1B, FIG. 1C and FIG. 1D of this prevent invention.

FIG. 3A, FIG. 3B, FIG. 3C and FIG. 3D illustrates are proceeded from the FIG. 2C, there are more types of the ionic conductive regions of this prevent invention.

FIG. 4A and FIG. 4B illustrates are combine with active material of this prevent invention.

FIG. 5A, FIG. 5B and FIG. 5C illustrates the current collector application in battery cell of this prevent invention.

### DETAILED DESCRIPTION

The present invention discloses a current collector, wherein the insulation regions can be prevent the electrical contacting with surface near the openings, the lithium ions would not deposit to the peripheral surface of the openings of holes, it can be effectively reduce lithium dendrites formed inside the holes and grow towards the separator during the electrical-chemical reaction of the battery. The current collector comprises a conductive substrate and a plurality of isolation regions. The conductive substrate has a plurality of holes. Each hole has two openings. The isolation regions, which only partially cover the surface of the conductive substrate, are disposed at least on the areas nearby the peripheral surface of the openings and extended to the areas except nearby the peripheral surface of the openings, further it can be extended to the plurality of holes and partially cover inner surface of plurality of holes. For the electrical insulation of the isolation regions, the lithium ions would not deposit centrally close to the openings of the holes during the electrical-chemical reaction of the battery. Accordingly, the lithium dendrites are not formed inside the holes and grow towards the separator and further the position and the amount of the formation of the lithium dendrite can be effectively controlled, solving the internal shortage and increases the safety of the battery.

Accordingly, the present invention is disclosed in detail . However, it should be understood that the detailed description and specific examples, while indicating preferred embodiments of the invention, are given by way of illustration only, since various changes and modifications within the spirit and scope of the invention will become apparent from this detailed description, and thus are not limitative of the present invention.

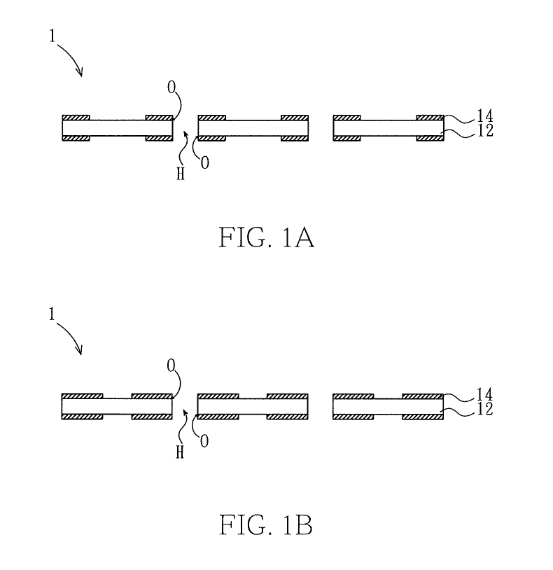

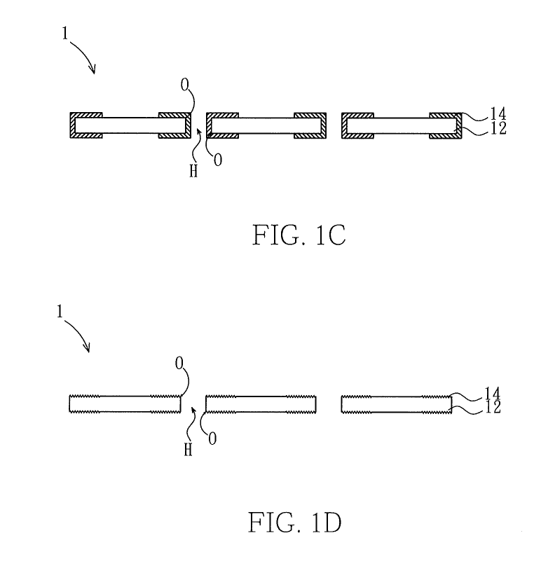

Reference the FIG. 1A, FIG. 1B, FIG. 1C and FIG. 1D illustrates having different isolation regions of this prevent invention.

Referring to FIG. 1A, the current collector 1A comprises a conductive substrate 12 and plurality of isolation regions 14, the conductive substrate 12 having plurality of holes H, each hole has two openings O. As shown in FIG. 1A, the hole H pass through the conductive substrate 12, so that the opening O is positioned on both surfaces of the conductive substrate 12, the isolation regions 14 is formed at the peripheral surface of the openings O. Due to the isolation regions 14 is electrically insulated, which the isolation regions 14 only partially cover the surface of the conductive substrate 12 to ensure that the conductive substrate 12 is electrical conductivity and at least part of the surface of the conductive substrate 12 is exposed.

Referring to FIG. 1B, as the FIG. 1A. The hole H of the conductive substrate 12 of the current collector 1A is a through hole, and the opening O is disposed correspondingly on both surfaces of the conductive substrate 12. The isolation regions 14 are disposed at least on the areas nearby the peripheral surface of the openings O and extended to the areas except nearby the peripheral surface of the openings O. In this embodiments the isolation regions 14 cover more surface of the conductive substrate 12.

FIG. 1C illustrates the current collector 1A, which the hole H is through the conductive substrate 12. The opening O is positioned on both surfaces of the conductive substrate 12. The different part is the isolation regions 14 disposed at least on the areas nearby the peripheral surface of the openings O and completely cover the inner surface of the hole H. In the practical application, the isolation regions 14 are disposed on the partially cover inner surface of plurality of holes H. (not shown)

The material of conductive substrate 12 must be selected from the lithium-inert material such as copper, nickel, iron, gold, zinc, silver, titanium or lithium-unalloyable. The electrolyte (not shown) selected from liquid electrolyte, solid electrolyte, gel electrolyte, liquid ion or any combination thereof.

In addition, FIG. 1A-1C illustrates the layer structure of the isolation regions 14, In FIG. 1D, the surface insulation is treated via passivation the isolation regions 14, the isolation regions 14 are disposed at least on the areas near the peripheral surface of the openings O and extended to the areas out of the peripheral surface of the openings O and/or extended to the part of inner surface of the hole H. In this embodiments of the present invention, the isolation regions 14 are formed around the peripheral surface of the openings O.

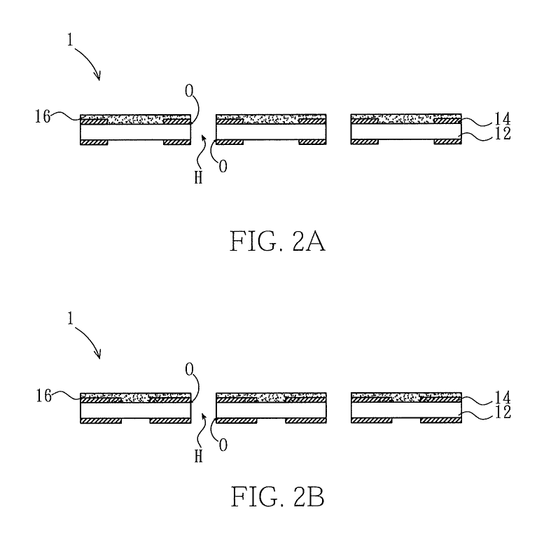

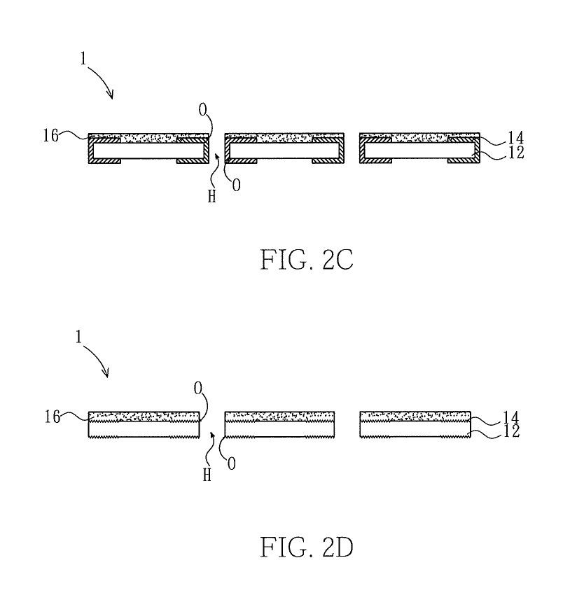

The current collector 1A further comprises at least an ionic conductive regions of the present invention, the ionic conductive region is disposed on at least one side of conductive substrate 12, and the ionic conductive regions are lithium-unalloyable. According to the above four types of the isolation regions 14, FIG. 2A, FIG. 2B, FIG. 2C and FIG. 2D are the embodiments of the current collector having ionic conductive regions evolve from FIG. 1A, FIG. 1B, FIG. 1C and FIG. 1D.

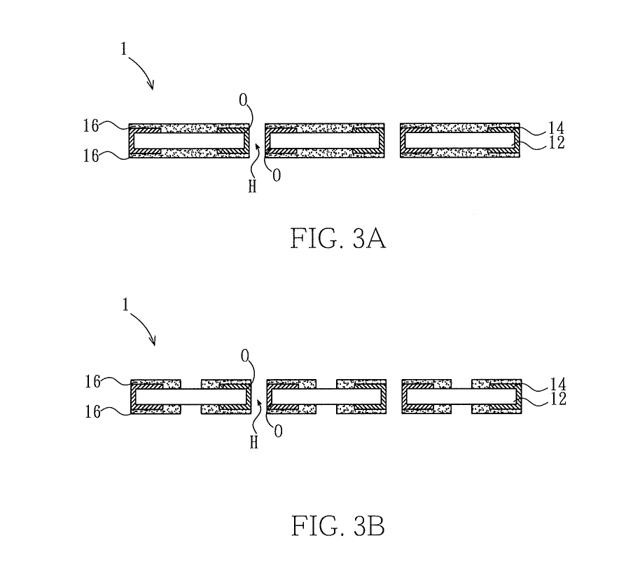

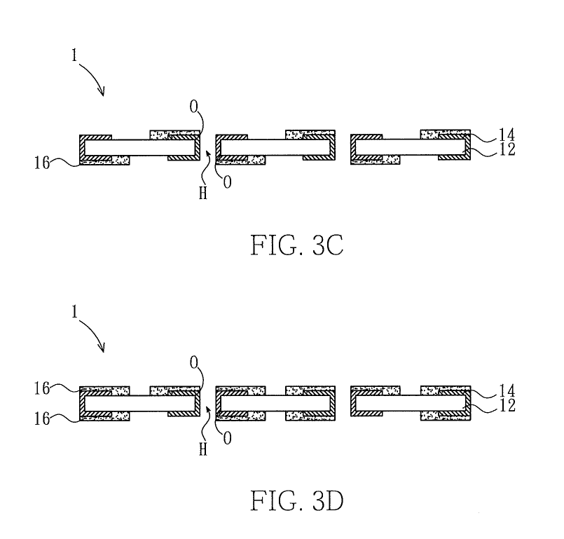

Please refer to the FIG. 2A, FIG. 2B, FIG. 2C and FIG. 2D, the current collector 1A of those embodiments comprises a conductive substrate 12, the plurality isolation regions 14 and the ionic conductive regions 16, the ionic conductive regions 16 are disposed on one side of conductive substrate 12, completely covering the conductive substrate 12 and the plurality isolation regions 14. In actual practice, FIG. 3A illustrates that the ionic conductive regions 16 can be disposed on both side of the conductive substrate 12. In the present embodiment, the ionic conductive region 16 is a continuous layer structure, but the ionic conductive regions 16 could be partially cover the conductive substrate 12 and/or the isolation regions 14, and the ionic conductive regions 16 could be individual structures, not a continuous layer structure. Furthermore, the ionic conductive regions 16 are disposed symmetrical or asymmetric in the plurality of individual structures. For example, as the FIG. 3B, FIG. 3C and FIG. 3D illustrates the ionic conductive regions 16 which disposed on both surface of the conductive substrate 12 by symmetrical, asymmetric or any combination thereof.

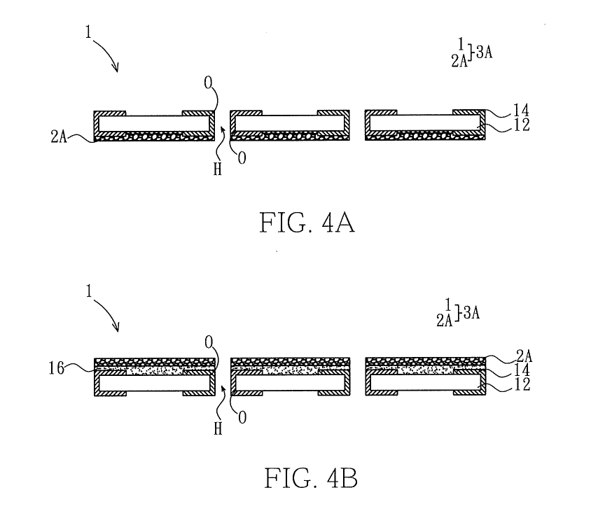

Moreover, the current collector 1A and the active material layer are disposed on each other and forming an electrode of this present invention. According to above types of the isolation regions 14 and the ionic conductive regions 16, FIG. 4A and FIG. 4B illustrates the current collector combination with the active material layer.

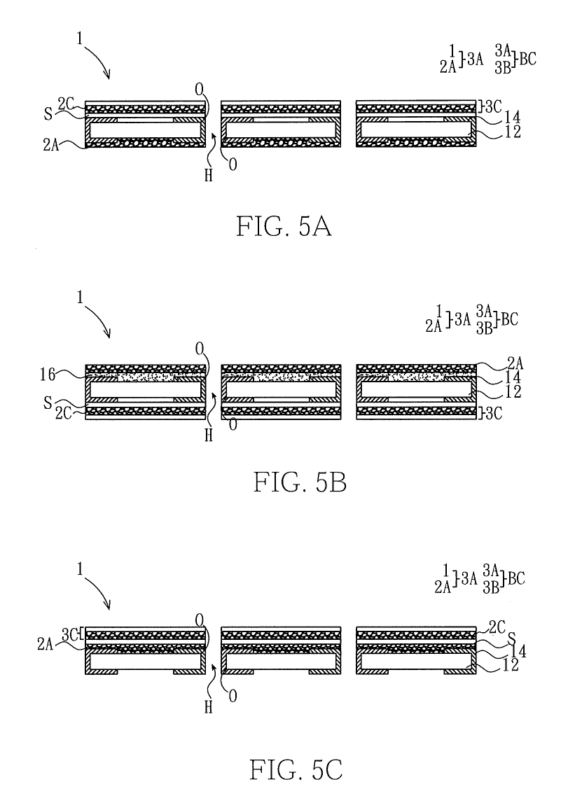

Referring to the FIG. 4A, the structure of the current collector 1A structure is shown as FIG. 1C. The current collector 1A comprises a conductive substrate 12 and plurality isolation regions 14. An active material layer 2A is provided on one side of the conductive substrate 12 to form an electrode 3A, the active material layer 2A is disposed adjacent to the isolation regions 14. FIG. 4B illustrates a current collector 1A having the conductive substrate 12, the isolation regions 14 and the ionic conductive regions 16 (as shown in FIG. 2C) and an electrode 3A which combine with the active material layer 2A. In this embodiment, the active material layer 2A is adjacent to the ionic conductive region 16. The electrode 3A is disclosed in FIG. 4A and FIG. 4B, the other side of the electrode 3A can combine with the separator S. As the FIGS. 5A and 5B, the other side of the separator S can further combine with another electrode 3C and become a battery cell BC (bicell). The above-mentioned active material layer 2A could be a metallic lithium layer, anode electrode active material layer, etc., and the current collecting layer 1A having the isolation regions 14 can reduce the deposition of lithium ions and control the deposition position of the lithium ions. Thus, the current collector 1A disclosed in the present invention is more suitable for the anode electrode layer. FIG. 5C illustrates another battery cell BC, the active material layer 2A of the electrode 3A and the active material layer 2C of the electrode layer 3C are individual adjacent both sides of the separator S, while the current collector 1A and the current collector 1C are correspondingly disposed on the other side of the active material layer 2A and the active material layer 2C, and the current collector 1A having isolation regions 14.

As shown in FIG . 5B, the electrode 3A in the above-mentioned battery cell BC is an anode electrode, the electrode 3C is a cathode electrode, and the active material of the electrode 2A is lithium metal. The potential is different between the electrode 3A and the electrode 3C in the battery cell BC during electrochemical reaction, in charge state, the lithium ions provided by the electrolyte in the battery cell BC (not shown) and the free lithium ions from electrode 3C begin to migrate toward the electrode 3A, the lithium ions will arrive at the conductive substrate 12 in the current collector 1A and pass through holes H of conductive substrate 12 in to the ionic conductive regions 16, and finally reach to active material layer 2A of electrode 3A; when the lithium ions reach the surface of the conductive substrate 12, the relative potential of the electrode 3A is close to the relative potential of the lithium, the lithium ion would start depositing on the surface of the conductive substrate 12 and forming lithium dendrite. However, the current collector 1A of the present invention has the isolation regions 14, the isolation regions 14 is insulated. The isolation regions 14 can prevent the lithium depositing on the region of the isolation regions 14. In this embodiment, the isolation regions 14 are disposed on the peripheral surface of the openings O of the hole H of the conductive substrate 12 and the inner surface of the hole H, so the reaction of lithium despotion would only on a part of the surface of the conductive substrate 12. At the same time, lithium ions continue to migrate toward the active material layer 2A, the lithium ions pass through the hole of the conductive substrate 12 and enter the ion conducting regions 16. The active material layer 2A often has a problem that the conductivity is uneven or the pore structure is uneven on its surface or inside. However, the ion-conducting region 16 has characteristic of high density and uniform porous structure and even, wide distribution. So the lithium ion would not be influence by conductivity or porosity of the active material layer 2A.

Accordingly, the ionic conductive regions 16 of the present invention is disclose in detail. Please refer to FIG. 5B, the main function of the ionic conductive regions 16 is to improve the efficiency of ion conduction between the conductive substrate 12 and the active material layer 2A, but the conductivity between the conductive substrate 12 and the active material layer 2A cannot be reduced. The best state of the ionic conductive regions 16 has the characteristics of ion conduction and electron conduction, the conductivity of ionic conductive regions 16 is provided by material, holes or an electrolyte material (ex: liquid electrolyte, gel electrolyte, solid electrolyte or a liquid ion, etc.) or any combination thereof, but the conductivity of the ionic conductive regions 16 is not limit to its own material or structure. In fact, the formation of the lithium dendrites will not grow in specific direction. The lithium dendrites pass through the ionic conductive regions 16 before contacted with the active material layer 2A, and the lithium dendrites is formed in the inner holes of the ionic conductive regions 16 as shown in FIG. 5B. The lithium dendrite is metal, the lithium dendrites formed in the ion conductive region 16 can effectively enhance the conductivity of the ionic conductive regions 16. In addition, the lithium dendrites formed in the ion conductive region 16 can be lithium ions provider in the electrochemical reaction inside the battery cell BC, when the active material layer 2A is a lithium metal layer, the above effect is more significant.

In addition, based on the lithium dendrite structure further extends from another types (not shown) of the ionic conductive regions, the lithium dendrites can be a conductive region when the lithium dendrites grow in the direction toward the active material layer. The lithium dendrite is conductive, and the holes between the lithium dendrite can provide ion conduction. Further, the above-mentioned ionic conductive regions, the ionic conductive regions could have higher A/C ratio (anode/cathode ratio), anode-like active material layer (not shown), comparing with the real anode active material layer, the anode-like active material layer can provide more embed position for lithium ion reaction because it contains more anode active materials. Within same reaction time, the lithium ions can be embed into the crystal structure of active material more than real anode active material layer. The lithium ions would not accumulate or deposit on the interface easily, maintain great ion conductivity

Referring to FIG. 5B again, the ionic conductive regions 16 is contact with the active material layer 2A directly, so the ionic conductive regions 16 must be lithium-unalloyable in any state, especially in the situation that the active material layer 2A is lithium metal layer. Based on the above, the ionic conductive regions 16 not only has the characteristics of ion-conducting, but also has a certain degree of electron conductive to make sure the conductivity of the current collector 1A. The material of the ionic conductive regions 16 may be lithium (lithium dendrite), and contains a ceramic isolation material, a polymer material, a liquid electrolyte, a gel electrolyte, a solid electrolyte, a liquid ion, a conductive material or the combination of materials. The ceramic isolation material comprises an oxidized metal, a sulfide metal, a nitride metal, a phosphorylated metal or an acidified metal, and the conductive material is a metal material, an alloy material, a conductive carbon material or a combination thereof, the conductive carbon comprises of carbon black, hard carbon, carbon nanotube, graphite, graphene and other conductive carbon. In the case of the structural of the ionic conductive regions 16 comprises a porous layered structure, a mesh structure, a columnar structure, or any combination structure thereof. The ionic conductive regions 16 have plurality of porous, which can be provided as channels for ion conduction, while after deposition and formation of the lithium dendrites, the channels can be connected to the active material layer 2A by the ionic conductive regions 16 to achieve electron conductive. According to the current collector is disclosed in the present invention, the isolation regions of the current collector is insulation, it can effectively provide lithium ion depositing during electrochemical reactions.

Accordingly, only few lithium dendrites are formed inside the holes and grow towards the separator so that the position and the amount of the formation of the lithium dendrite can be effectively controlled by isolation regions. Thus, the safety of the battery can be greatly improved, and extend the cycle life of battery.

The invention being thus described ; it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An current collector, comprising:
a conductive substrate, having a plurality of holes, and each of the hole has two openings; and
a plurality of isolation regions, forming at least partially on a peripheral surface of each of the openings and at least parts of a surface of the conductive substrate are exposed.

2. The current collector of claim 1, wherein at least one of the isolation regions further extend outward the peripheral surface of the opening and partially cover the surface of the conductive substrate.

3. The current collector of claim 1, wherein at least one of the isolation regions further extend inward the peripheral surface of the opening and partially cover an inner surface of the hole.

4. The current collector of claim 1, wherein the isolation regions are electrical insulated.

5. The current collector of claim 1, wherein the isolation region comprises at least one electrical insulation material.

6. The current collector of claim 1, wherein the isolation region is an electrical insulation layer, or an electrical-insulation-treated surface.

7. The current collector of claim 1, wherein an active material layer is further disposed adjacent to the conductive substrate and the isolation regions.

8. The current collector of claim 7, wherein the active material layer is a lithium metal layer.

9. The current collector of claim 1, further comprising:
at least a ionic conductive region, being lithium-unalloyable and disposed on at least one of a surface of the conductive substrate.

10. The current collector of claim 9, wherein the ionic conductive region is further electrical conductive.

11. The current collector of claim 9, wherein the ionic conductive region is porous.

12. The current collector of claim 9, wherein the ionic conductive region is in a shape of layer shape, grid shape, cylindrical shape and a combination thereof.

13. The current collector of claim 9, wherein the ion conductive region is further made of materials selected from the group consisting of a ceramic insulating material, a polymer, a liquid electrolyte, a gel electrolyte, a solid electrolyte, a liquid ion, a conductive material and a combination thereof.

14. The current collector of claim 13, wherein the ceramic insulating material is made of materials selected from the group consisting of oxidized metal, sulfurized metal, nitride metal, phosphorylated metal, acidified metal and a combination thereof.

15. The current collector of claim 13, wherein the conductive material is made of materials selected from the group consisting of a metal, an alloy, a conductive carbon material and any combination thereof.

16. The current collector of claim 13, wherein the conductive carbon material comprises of carbon black, hard carbon, carbon nanotube, graphite, graphene or any other conductive carbons.
